(19) United States
(12) Patent Application Publication
(10) Pub. No.: US 2026/0158417 A1
(43) Pub. Date: Jun. 11, 2026

(54) SEPARATION COLUMN WITH VARIABLE GEOMETRY

(71) Applicant: ECZACIBASI MONROL NÜKLEER ÜRÜNLER SANAYI VE TICARET ANONIM SIRKETI, Gebze/Kocaeli (TR)

(72) Inventors: Mehmet Tunç TUNÇEL, Gebze/Kocaeli (TR); Tahsin PEHLIVAN, Gebze/Kocaeli (TR); Isil ÇORUH, Gebze/Kocaeli (TR); Mustafa ÇAKMAK, Gebze/Kocaeli (TR)

(21) Appl. No.: 18/706,430

(22) PCT Filed: Jun. 9, 2022
(86) PCT No.: PCT/TR2022/050552

§ 371 Date: May 1, 2024

(30) Foreign Application Priority Data
Nov. 5, 2021 (TR) 2021/017245

(51) Int. Cl. B01D 15/22; C22B 59/00; G01N 30/60

(52) U.S. Cl. CPC B01D 15/22; C22B 59/00; G01N 30/6065

(57) ABSTRACT

Disclosed is a separation column used for separating the substances in a mixture. The separation column includes sections with different cross-sectional areas where a mixture desired to be separated is separated by way of passing the same along with a mobile phase through a stationary phase.

### SUBJECT OF THE INVENTION

The invention relates to a separation column used for separating the substances in a mixture.

### STATE OF THE ART

Chromatography is a frequently preferred method in the applications where it is desired to separate two or more components in a mixture. The separation is realized by moving the components, which are desired to be separated by way of chromatography, at varying velocities through a stationary phase with the help of a mobile phase. In other words, the component desired to be separated is added to a stationary phase and is separated owing to the mobile phase flowing over this stationary phase.

A chromatography system basically consists of three components, namely a stationary phase, a mobile phase and a mixture desired to be separated. The mobile phase, along with the mixture desired to be separated it contains, moves over the other phase that is stationary. The length of the column section where the separation is to take place directly affects the separation efficiency and thus the separation time. More specifically, when the mixture desired to be separated is charged in the system along with the mobile phase, the separation occurs only in the section where the mobile phase and the mixture will move. Accordingly, extending the section where the separation is to take place by increasing the column length brings about efficiency increase in some applications. However, due to some constraints, it is not possible in all cases to increase the column length by the desired extent and the column length is required to stay within certain upper limits. The applications in which the radioactive substances are separated are an example for this situation.

In the separation column according to the invention, the length of the section of the column designated for separation may be increased without increasing the column length, and in this way, an increase in the efficiency and a reduction in the separation time may be achieved.

### OBJECT OF THE INVENTION

An object of the invention is to develop a separation column wherein the separation efficiency is increased and the separation time is reduced.

Another object of the invention is to develop a separation column wherein the separation efficiency is increased without increasing the column length.

### DESCRIPTION OF THE FIGURES

FIG. 1 A view of an exemplary embodiment of the column according to the invention

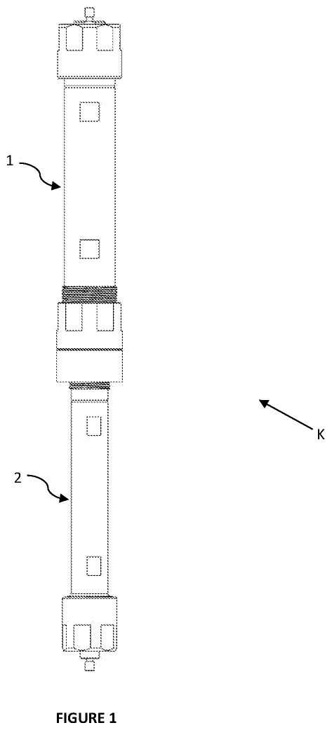

FIG. 2 A sectional view of an exemplary embodiment of the column according to the invention

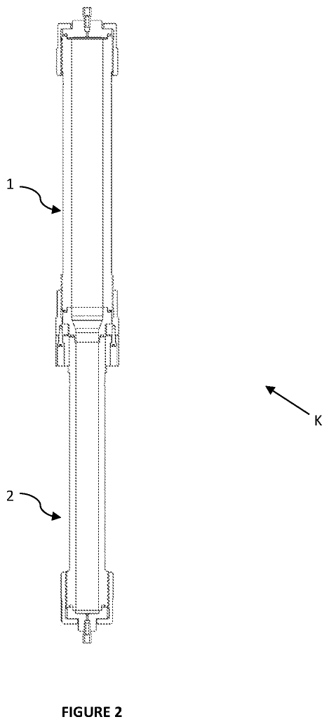

FIG. 3 A view of an exemplary embodiment of the column according to the invention having three sections

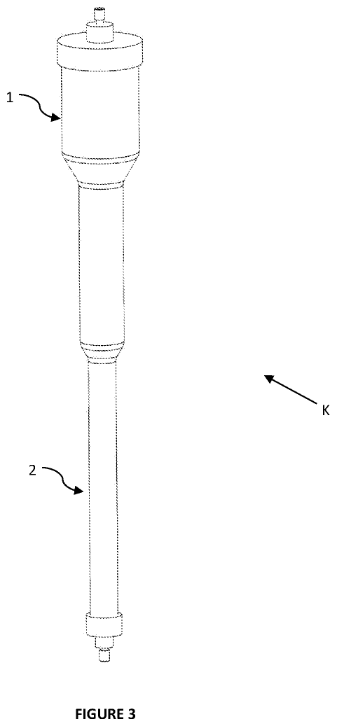

FIG. 4 A sectional view of an exemplary embodiment of the column according to the invention having three sections

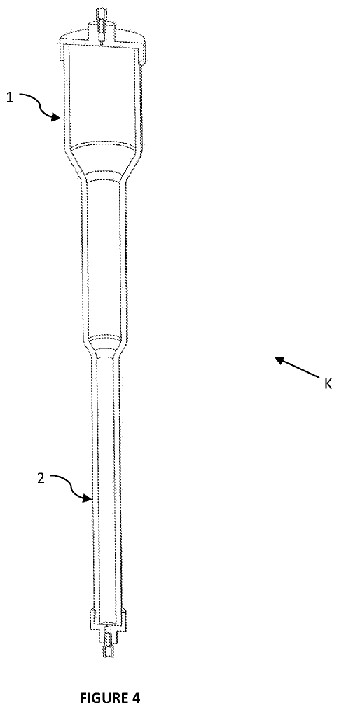

FIG. 5 A view of an exemplary embodiment of the column according to the invention where the column cross-sectional area varies linearly

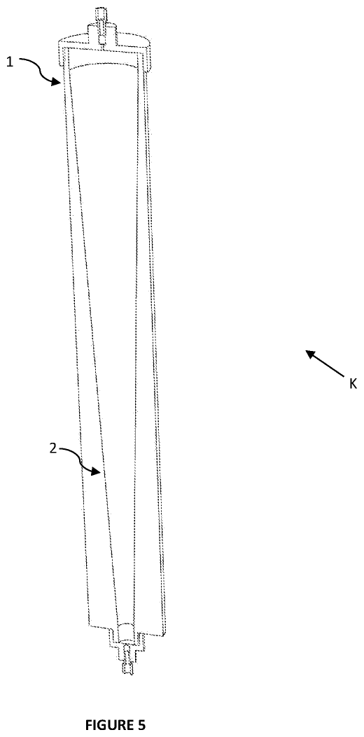

### REFERENCE NUMERALS

K: Column
1: Charging section
2: Separation section

### DETAILED DESCRIPTION OF THE INVENTION

The invention relates to a separation column (K) used for separating the substances in a mixture. More particularly, the invention relates to a separation column (K) comprising sections with different cross-sectional areas where a mixture desired to be separated is separated by way of passing the same along with a mobile phase through a stationary phase.

Via the extraction chromatography technique, two or more substances with very similar chemical properties may be separated from one another. The substances to be separated are charged in the column (K) along with an acid of certain molarity. Then, the acid with a different molarity is passed through the column (K) to advance the charged substances within the column (K). The substances to be subjected to separation move at a certain velocity downward from the top along the upright column (K). The column (K), according to the nature of the resin used within the same, creates a phase difference for the substances passing through the same, and thus, enables the movement within the column (K).

The column (K) according to the invention has sections with variable geometry, more specifically, with variable cross-sectional area. In other words, it is a column (K) having at least two sections with different cross-sectional areas.

A preferred embodiment of the invention is a column (K) comprising a first section, in other words a charging section (1), in which the mixture to be separated is charged in the system and which has larger a cross-sectional area compared to the other section, and a second section, in other words a separation section (2), which has a smaller cross-sectional area compared to the first section. The separation section (2) is the section where the mixture charged in the charging section (1) is separated.

In the embodiment of the invention where the mixture to be separated is charged in the column (K) via the top part of the column (K), the charging section (1) with larger cross-sectional area is located at the upper part of the column (K), while the separation section (2) with smaller cross-sectional area is located at the lower part of the column (K). More specifically, the cross-sectional area of the inlet section of the column (K) is greater compared to the cross-sectional area of the outlet section.

In a preferred embodiment of the invention, the cross-sectional area of the column (K) increases and/or decreases linearly. More specifically, while the cross-sectional area of the column (K) is at a maximum at the inlet section, the cross-sectional area decreases linearly towards the outlet section of the column (K), reaching its minimum at the outlet section.

In another preferred embodiment of the invention, the column (K) has a stepped structure. More specifically, the cross-sectional area is at a maximum at the inlet section of the column (K) and the cross-sectional area continues with its maximum along a predetermined length. Then, the cross-sectional area of the column (K) decreases to a comparatively smaller cross-sectional area and continues with this cross-sectional area along a predetermined length. In other words, the cross-sectional area of the column (K) does not increase or decrease linearly; it increases or decreases in a stepwise manner. In a preferred embodiment of the invention, the column (K) comprises more than two sections having different cross-sectional areas, and thus, it has more than two steps.

In a preferred embodiment of the invention, the column (K) has a circular cross-section.

Owing to the cross-sectional area being larger at the inlet section of the column (K), more mixture is present per unit length in this section, compared to the section with smaller cross-sectional area. In this way, a greater part of the column (K) in terms of length may be used for separation.

More specifically, described by an example;
In an embodiment of the state of the art where the length of the column (K) is 10x and the cross-sectional area of the column (K) is x², when a mixture to be separated with a volume of 4x³ is charged, a part of the column having the length of 6x may be used for separation.
In an embodiment of the column (K) according to the invention where the length of the column (K) is 10x, the charging cross-sectional area is 2x² and the separation cross-sectional area is x², when a mixture to be separated with a volume of 4x³ is charged, a part of the column having the length of 8x may be used for separation.

As can be understood from the example above, in case a column (K) with variable geometry is used, the separation efficiency increases and the time required for separation decreases, since the height occupied by the mixture to be separated may be reduced and a greater part may be devoted to separation.

In a preferred embodiment of the invention, at least one plug is located at the column (K) inlet end and/or column (K) outlet end. Said plugs are secured via at least one cap so that they can resist the pressure inside the body of the column (K). Said cap is preferably a threaded cap. The separation with the column (K) according to the invention is performed via the following process steps:
Charging the radioactive substance in the column (K) via the column (K) inlet with an acid of certain molarity,
the radioactive substance accumulating in the top portion of the body of the column (K), more specifically at the column (K) inlet end, more specifically at the charging section (1),
directing the acid used for charging to the drain via the column (K) outlet,
changing the molarity of the acid introduced to the column (K) inlet, and thus, enabling the charged radioactive materials desired to be subjected to separation to move inside the column (K), more specifically inside the separation section (2),
after the start of said movement, the radioactivity detector detecting the activity of the mixture within the separation section (2), and
moving on to the next process step according to the activity detected.

The acid passed through the column (K) creates a pressure in the range of 3-25 bar inside said column (K) depending on the size of said column (K) and said column (K) is a column (K) with structure capable of resisting said pressure.

In a preferred embodiment of the invention, said column (K) is a column (K) used for the separation of the rare earth elements. In another preferred embodiment of the invention, said column (K) is a column (K) used for the separation of the radioactive substances. In another preferred embodiment of the invention, said column (K) is a column (K) used for the separation of ytterbium and lutetium. More particularly, it is a column (K) used for the separation of ytterbium 176 (Yb-176) isotope and lutetium 177 (Lu-177) isotope.

The separation column (K) with variable geometry according to the invention is used in the separation devices enabling the separation of more than one radioactive substance. The chromatography device, which is used for the separation of radioactive substances and which comprises said separation column (K) with variable geometry, is also within the scope of the invention.

1. A separation column used for separating the substances in a mixture wherein the column comprises at least two sections having different cross-sectional areas, wherein the column is a column comprising a first section, in other words a charging section, which has a larger cross-sectional area compared to the other section, and a second section, in other words a separation section, which has a smaller cross-sectional area compared to the first section, in other words the charging section.

2. (canceled)

3. (canceled)

4. (canceled)

5. (canceled)

6. A separation column according to claim 1, wherein the cross-sectional area of the inlet section of the column is larger than the cross-sectional area of the outlet section.

7. A separation column according to claim 1, wherein the column is a column, the cross-sectional area of which linearly decreases from the inlet section towards the outlet section.

8. A separation column according to claim 7, wherein the column is a column in which the cross-sectional area is at a maximum in the inlet section, the cross-sectional area linearly decreases towards the outlet section and the cross-sectional area is at a minimum in the outlet section.

9. A separation column according to claim 1, wherein the column is a column having a stepped structure.

10. A separation column according to claim 9, wherein the column is a column in which the cross-sectional area is at a maximum in the inlet section and continues with its maximum along a predetermined length, and then, the cross-sectional area decreases to a comparatively smaller cross-sectional area and continues with this cross-sectional area along also a predetermined length.

11. A separation column according to claim 9, wherein the column is a column, the cross-sectional area of which increases or decreases in a stepwise manner.

12. (canceled)

13. (canceled)

14. (canceled)

15. A separation column according to claim 1, wherein the column is a column used for the separation of rare earth elements.

16. A separation column according to claim 1, wherein the column is a column used for the separation of the radioactive substances.

17. A separation column according to claim 1, wherein the column is a column used for the separation of lutetium and ytterbium.

18. A separation column according to claim 17, wherein the column is a column used for the separation of ytterbium 176 isotope and lutetium 177 isotope.

19. (canceled)

20. (canceled)

21. (canceled)

22. A separation column according to claim 1, wherein the column is a column resistant to the pressure created by the acid, which is passed through said column at a pressure of 3-25 bar depending on the size of said column.

23. A chromatography device used for the separation of more than one radioactive substance, wherein the chromatography device comprises the column according to claim 1, having sections with variable cross-sectional areas.

24. Separation method used for separating the substances in a mixture via a separation column, wherein the separation method comprises the steps of:
charging the radioactive substance in the column via a column inlet with an acid of certain molarity,
the radioactive substance accumulating in the top portion of the body of the column, more specifically at a column inlet end, more specifically at a charging section,
directing the acid used for charging to drain via a column outlet,
changing the molarity of the acid introduced to the column inlet, and thus, enabling the charged radioactive materials desired to be subjected to separation to move inside the column, more specifically inside a separation section, and
after the start of said movement, a radioactivity detector detecting the activity of the mixture within the separation section.

25. A separation method according to claim 24, wherein the acid is passed through the column in a way to create a pressure in the range of 3-25 bar inside said column depending on the size of said column.
